(19) United States
(12) Patent Application Publication
(10) Pub. No.: US 2009/0058070 A1
(43) Pub. Date: Mar. 5, 2009

(54) 3-D DEVICE THAT MAY BE DECORATED AND METHODS THEREFOR

(75) Inventor: Yekaterina Nagorneva, Atlanta, GA (US)

Correspondence Address: NORA M. TOCUPS, P.O BOX 698, 140 PINECREST AVE, DECATUR, GA, 30030, US

(73) Assignee: SOUTHERN STATES MARKETING, INC., Marietta, GA (US)

(21) Appl. No.: 12/105,255

(22) Filed: Apr. 17, 2008

Related U.S. Application Data
(60) Provisional application No. 60/968,936, filed on Aug. 30, 2007.

(51) Int. Cl. B42D 1/00

(52) U.S. Cl. 281/38

(57) ABSTRACT

The inventions include an embodiment to give a design a 3-D characteristic. A board has an indicator for positioning a middle piece on the board. The board includes at least a first element of the design. The middle piece is shaped substantially as the indicator and substantially covers it when the middle piece is placed over the indicator. The middle piece has a positioning aid for placing a top piece on the middle piece. The middle piece includes at least a second element of the design. The top piece is shaped substantially as the positioning aid and substantially covers it when the top piece is placed over the positioning aid. The top piece includes at least a third element of the design. Positioning the middle piece on the board and placing the top piece on the middle piece gives the design the 3-D characteristic. The embodiment may be decorated.

### CROSS-REFERENCE TO RELATED APPLICATION

The present application claims priority to and benefit of the prior filed co-pending and commonly owned provisional application, filed in the United States Patent and Trademark Office on Aug. 30, 2007, assigned Ser. No. 60/968,936, entitled A 3-D Device That May be Decorated and Methods Therefor, and incorporated herein by reference.

### FIELD OF THE INVENTIONS

The inventions relate generally to two dimensional devices being used to create a three-dimensional effect with respect to designs on the devices.

### BACKGROUND

There are many ways to keep a child entertained. One of those ways is to provide him or her with a coloring book. Generally, a coloring book includes pages with black line drawing. A child may use crayons or markers to add color to the line drawings.

### SUMMARY

Generally stated, the inventions relate to two dimensional devices being used to create a three-dimensional effect with respect to designs on the devices. The inventions are described herein as having specific elements and features, but should not be limited to the particular examples given. One or more of the inventions may be used in other circumstances and/or with other elements or features.

An exemplary embodiment of the inventions is an apparatus to give a design a three-dimensional (3-D) characteristic. The design may include first, second, and third elements. The elements may include line drawing with at least a space in the line drawing in each of the first, second, and third elements, whereby decoration may be added to one or more of the spaces.

The exemplary apparatus includes a board and a middle and top pieces. They may each be substantially flat. The board may be thicker than either the middle or top pieces. Either or both the middle and top pieces may be made to adhere, respectively, to the board and to the middle piece. The exemplary apparatus may include a means for supporting the board with the positioned middle and top pieces to display the design with the 3-D characteristic. For example, the exemplary apparatus may include a loop for hanging or a fold-out leg as support for upright display.

The board includes at least a first element of the design. The board also includes an indicator for positioning the middle piece on the board. The indicator may be a first shaded area. The board may include another indicator for positioning another middle piece on the board. The other middle piece may be shaped substantially the same as the other indicator and may substantially cover the other indicator when the other middle piece is placed on the other indicator on the board.

The middle piece includes at least a second element of the design. The middle piece is shaped substantially the same as the indicator on the board. The middle piece substantially covers the indicator when the middle piece is placed over the indicator on the board. The middle piece has a positioning aid for placing a top piece on the middle piece. The positioning aid may be a second shaded area. The middle piece may include another positioning aid for placing another top piece on the middle piece. If another middle piece is being used with the exemplary apparatus, the other middle piece may include a positioning aid for placing a top piece on the other middle piece.

The top piece includes at least a third element of the design. The top piece is shaped substantially the same as the positioning aid on the middle piece. The top piece substantially covers the positioning aid when the top piece is placed over the positioning aid on the middle piece. The positioning of the middle piece on the board and the placing of the top piece on the middle piece give the design the 3-D characteristic. If another top piece is being used with the exemplary apparatus whether on the middle piece or on another middle piece, the other top piece may be shaped substantially the same as the other positioning aid on the appropriate middle piece. The other top piece may substantially cover its positioning aid when the other top piece is placed on the other positioning aid.

The exemplary apparatus may include a board that is substantially flat and that includes a top and a back. The middle piece and the top piece (mentioned above) may be positioned on top of the board. The back of the board, however, also may include a back indicator for positioning a back piece on the back of the board.

The inventions also include another exemplary embodiment referred to herein as a device. The device includes a base with a drawing on top. The device also includes a piece that is positionable on a part of the drawing on the base. The piece may be shaped the same as the part of the drawing on the base over which the piece is positionable.

The piece has a top, which includes a substantial duplication of the part of the drawing on the base over which the piece is positionable. The device further includes a top piece that is positionable on a portion of the substantial duplication on the piece. The top piece may be shaped the same as the portion of the substantial duplication on the piece over which the top piece is positionable.

The top piece has a top area, which includes a substantial duplicate of the portion of the substantial duplication on the piece over which the top piece is positionable.

The exemplary device may include another piece positionable on another part of the drawing on the base. The other piece may have a corresponding top. It may include a substantial copy of the other part of the drawing on the base over which the other piece is positionable.

The exemplary device may include another top piece positionable on another portion of the substantial duplication on the piece. The other top piece may have a corresponding top area. It may include a substantial duplicate of the other portion of the substantial duplication on the piece over which the other top piece is positionable.

The inventions further may include an exemplary embodiment referred to herein as an apparatus for accentuating elements of a design. The design has top, middle and bottom elements. The exemplary apparatus includes a top, middle, and bottom parts. The top part has a top depicting the top element of the design. The middle part depicts the middle element of the design on top of the middle part. The middle part includes an area for placement of the top part without covering the middle element of the design. The area may be shaded. The bottom part depicts the bottom element of the design on top of the bottom part. The bottom part includes a space for placement of the middle part without covering the bottom element of the design. The space may be shaded. In this embodiment, placing the middle part on the space of the bottom part without covering the bottom element of the design, and placing the top part on area of the middle part without covering the middle element of the design accentuates the middle and top elements of the design.

In addition, the inventions include an exemplary embodiment referred to herein as a three-dimensional (3-D) puzzle. It includes a substantially flat board having a first indicator for positioning a first middle piece on top of the board. The board also includes a second indicator for use in placement of a second middle piece on top of the board. The first middle piece is shaped substantially the same as the first indicator, and the second middle piece being shaped substantially the same as the second indicator. The first middle piece has a first positioning aid for positioning a first top piece on top of the first middle layer. The second middle layer has a second positioning aid for use in positioning a second top piece on top of the second middle layer. The first top piece is shaped substantially the same as the first positioning aid. The second top piece is shaped substantially the same as the second positioning aid.

In a variation, the substantially flat board of the 3-D puzzle has a back opposite to the top of the board. The back of the board may have a back indicator for positioning a back piece on the back of the board.

Four exemplary embodiments according to the inventions have been summarized above. Many more are possible; the inventions are not to be limited to these examples. Other features and advantages of the inventions may be more clearly understood and appreciated from a review of the following detailed description and by reference to the appended drawings and claims.

### BRIEF DESCRIPTION OF THE DRAWINGS

FIG. 1 shows an exemplary embodiment according to the inventions.

FIG. 2 shows an element of the exemplary embodiment shown in FIG. 1.

FIG. 3 shows another element of the exemplary embodiment shown in FIG. 1.

FIG. 4 shows yet another element of the exemplary embodiment shown in FIG. 1.

FIG. 5 is an exploded view of the elements shown in FIGS. 2-4

### DETAILED DESCRIPTION

The inventions are described herein with reference to exemplary embodiments, alternative embodiments, and also with reference to the attached drawings. The inventions, however, can be embodied in many different forms and carried out in a variety of ways, and should not be construed as limited to the embodiments set forth in this description and/or the drawings. The exemplary embodiments that are described and shown herein are only some of the ways to implement the inventions. Elements and/or actions of the inventions may be assembled, connected, configured, and/or taken in an order different in whole or in part from the descriptions herein.

Generally stated, the inventions relate to a device that may include a drawing with selected elements of the drawing being pieced and arranged into layers so that appropriate positioning of the selected elements may result in creating a three-dimensional (“3-D”) effect of the drawing. One or more of the selected elements as well as other portions of the drawing may be decorated.

More particularly described, the “device” of the inventions may be referred to as a “3-D poster”, “posterboard”, a “3-D board”, “3-D poster board”, “3-D puzzle board” or by similar terms. The device may include a drawing (such as line art, line-drawing or otherwise), depiction, photograph, text, numbers, graphics, and/or the like (separately or in combination) (all options being referred to herein simply as “drawing”).

A drawing (according to the inventions) may include elements. The elements of a drawing may include one or more constituent parts of the drawing. For example, a drawing may depict a young woman holding a bouquet with a castle in the background. Another example may be a drawing made up completely of text. The text-only drawing may include elements such as words, letters, punctuation, numbers, and/or combinations thereof. A drawing may include one or more elements.

A particular aspect of the inventions is that one or more elements of a drawing may be selected to be treated differently from the other elements of the drawing. These selected elements may be pieced and/or otherwise made separate from the drawing. For example, one or more selected elements may be die-cut from material that is the same as or similar to the remaining elements of the drawing. When a selected element is pieced from the drawing, the selected element may be duplicated so that the drawing from which the selected element is taken remains whole. Alternatively, when a selected element is pieced but not duplicated, that portion of the drawing where the selected element was located may be shaded, and/or otherwise depicted or illustrated.

A device may include selected elements that are duplicates and/or are not duplicates. A selected element that has been pieced from its drawing also may be referred to as a “piece”, “poster piece”, “die-cut poster piece” or by a similar term. The “unselected” elements of the drawing are referred to herein as the “other elements”, “remaining elements” or “base elements” of the drawing. As noted, the base elements may include the entire drawing if all of the selected elements are duplicated when they are pieced.

The selected elements of the drawing may be layered with respect to the other (unselected) elements of the drawing and/or with respect to each other. One or more selected elements may be layered in a stack. Specifically, the selected elements may be positioned so that a stack of layers including one or more selected elements lends a 3-D effect to the drawing. Advantageously, the 3-D technique of the inventions allows specific features of a drawing to be accented.

A selected element that is layered may be glued or otherwise affixed to material upon which the selected element is layered. A selected element may be affixed by a self-adhesive on its underside to allow the selected element to stick to the layer and/or other elements underneath the selected element. In some embodiments, selected elements may be permanently fixed in position and/or may be removably fixed in position.

Another advantage of the invention is that the design and its elements may be decorated. A user may decorate a selected element before or after it is positioned or layered and/or before or after the selected element is fixed in its place. A user also may decorate the other elements of the design. For example, the device may be colored with paints, markers, crayons, colored pencils, highlighters and the like. Alternatively, or in addition, the device may be decorated with glitter, glitter glue, plastic jewels, sequins, ribbons, wiggle eyes, eva foam pieces, cotton balls, fabric pompoms and the like. An exemplary embodiment may allow a user to color a selected element and further enhance it by adding glitter.

The design including the selected and other elements may include features for display of the design. For example, an embodiment may include an adhesive hanger on the underside of its base and/or may include a prop or fold-out stand to support the design and/or other mechanism to aid in display of the device.

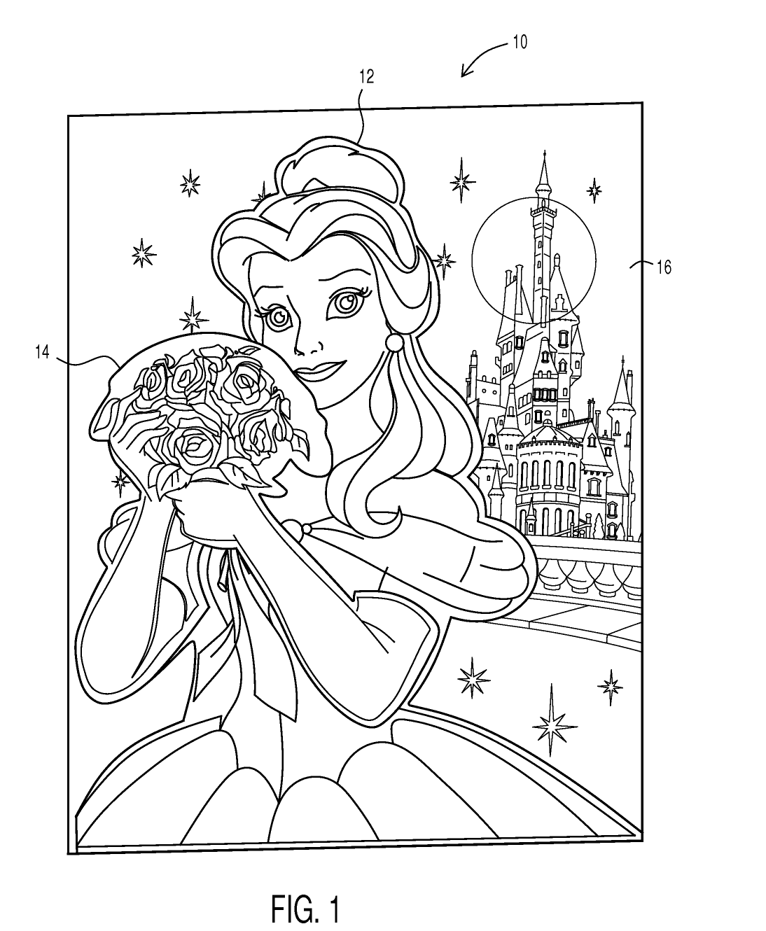

FIG. 1 illustrates an embodiment 10 of the inventions. The exemplary device 10 includes a black-and-white line-drawing of a young woman 12 holding a bouquet 14 with a castle in the background 16. The term “line-drawing” is used herein to describe the fact that only lines are used to create the elements in the drawing, and that there are no shadings, fill-ins, or other features or techniques other than the use of lines to create the overall drawing. “Line-drawing” is the technique used in many coloring books. Other embodiments may create a drawing for use with a device other than by line-drawing or by using line-drawing plus some other feature(s) and/or technique(s).

Specifically, FIG. 1 illustrates a device 10 with three layers positioned or layered so as to give the drawing of the device 10 a 3-D effect. In this example, the background including the castle 16 is used as the first or bottom layer of the device 10. The element of the drawing 10 including the young woman 12 is the second or middle layer of the device 10. The element of the drawing 10 including the bouquet 14 is the third or top layer of the device 10. By the selection of the young woman 12 for the middle layer and the bouquet 14 for the top layer, and their layering on top of the bottom layer including the castle 16, the young woman 12 appears to be closer to the viewer than the castle 16, and the bouquet 14 appears to be closer to the user than the young woman 12. The young woman 12 and especially the bouquet 14 appear to “pop out” at the viewer—at least more than the background. In fact, the middle and top layers of the device 10 are closer to the viewer by the layering of the three layers in the particular order specified. Further details below describe how this 3-D effect is achieved.

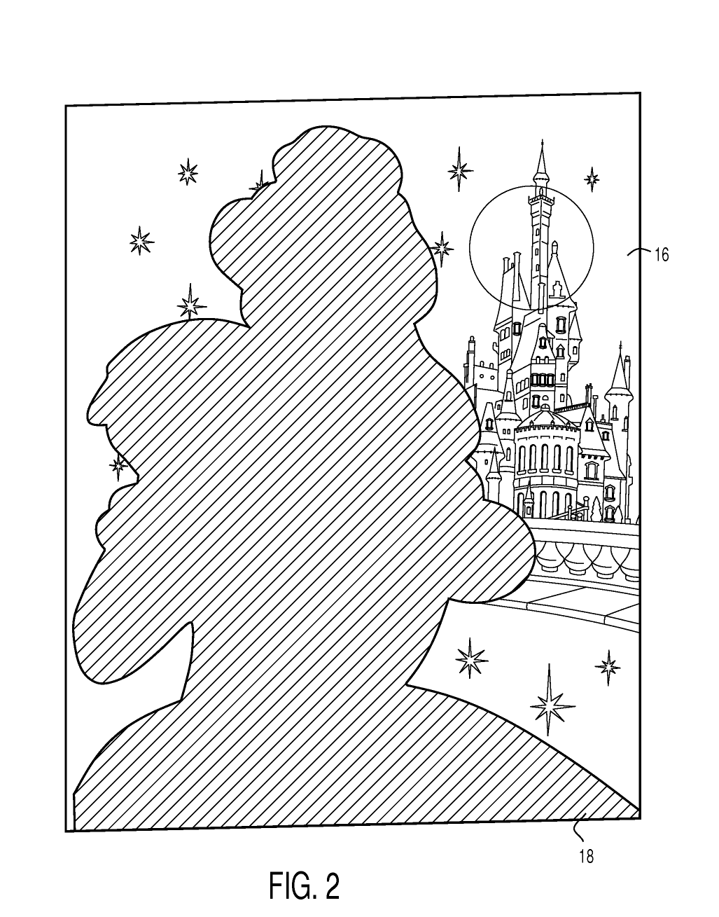

FIG. 2 illustrates the first layer 16 of the exemplary device 10 shown in FIG. 1. The first layer 16 also may be referred to as the bottom layer or the backer board. The first layer 16 is a generally flat item that may be made of cardboard, puzzle piece board, backer board, or other materials. The exemplary first layer 16 is made from a grey, white or black chipboard with a white laminated cover. Other colors and/or appropriate materials separately or in combination may be used. The other layers of a device may be similar in construction to the base layer, may be made of the same material as the bottom layer and/or may be made of other materials.

The exemplary first layer 16 is generally rectangular, but other first layers may be of any shape. The exemplary first layer 16 has a generally overall depth or thickness of about two millimeters (2 mm)—between ⅛^{th}-¼^{th} of an inch; other first layers may be of other depths or thicknesses. The thickness of the exemplary first layer 16 gives it a bit of stiffness that may be advantageous in use, transport, and/or storage of the exemplary device 10. The exemplary first layer 16 is approximately 8×10 inches in size, but may be any selected size.

FIG. 2 also shows that the bottom layer 16 includes elements of the overall black-and-white line-drawing of the exemplary device 10, and in particular, includes the background with the castle. The background with the castle may be considered “unselected” elements because they have not been pieced apart from the overall drawing. The bottom layer 16 does not include the elements of the drawing that are included in the other layers. Particularly, the line-drawing on the bottom layer 16 does not include the young woman nor the bouquet. They are selected elements of the drawing. Instead, a silhouette 18 is substituted where the other layers 12, 14 of the exemplary design 10 are to be positioned to complete the overall drawing. Advantageously, the silhouette 18 in the bottom layer 16 makes it easy for a user to properly position the next layer, which is the middle layer 14 in this example, with respect to the bottom layer 16.

As noted, the bottom layer 16 of the exemplary device 10 includes a silhouette 18 instead of the drawings of the young woman and the bouquet. Another embodiment may omit the silhouette 18 and instead include the drawings of the young woman and the bouquet even though other layers may also include those drawings. In that case, the user may be able to decorate each of the drawings in a different way for variety or otherwise. Alternatively, another embodiment may include some of the drawings of the other layers, but not the complete drawings of the other layers. As yet another alternative, another embodiment may include a drawing(s) on the bottom layer of something(s) other than that depicted on the other layers of that part of the device or otherwise.

Also as noted, the silhouette 18 in the bottom layer 16 of the exemplary device 10 is blank, but it may be filled-in or shaded in black. Other color(s) may be used. Other techniques may be used to indicate the area where the other layers of elements are to be positioned.

A user may color and/or decorate the bottom layer 16 (in whole or part) prior to positioning one or more of the remaining layers. Alternatively, a user may elect to color and/or decorate the bottom layer 16 when one or more of the other layers are positioned.

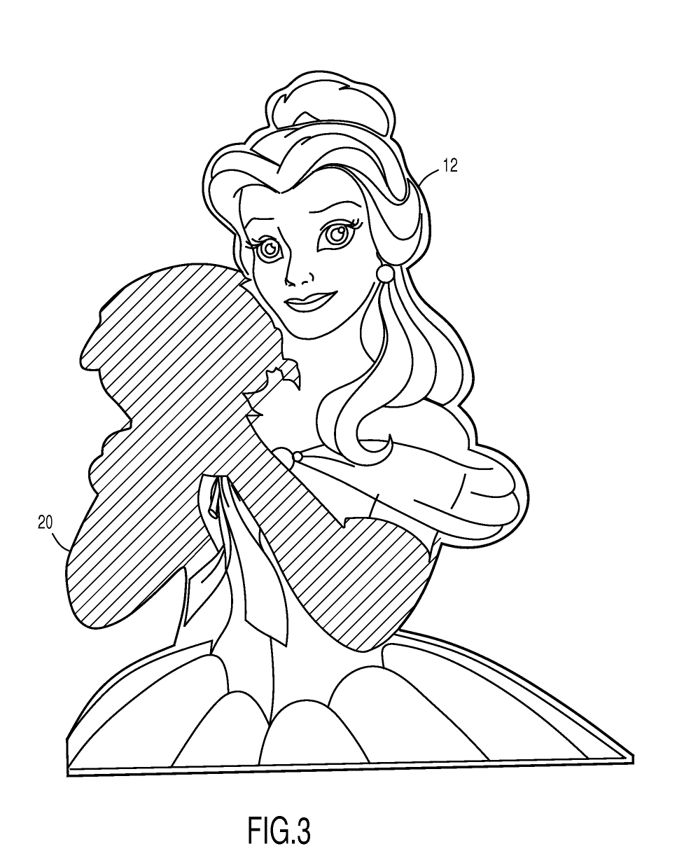

FIG. 3 illustrates the exemplary middle layer including the black-and-white line drawing of the young woman 12. In this example, the element of the drawing referred to as the “young woman” is more or less synonymous with the term “middle layer” 12 because the middle layer 12 only includes the drawing of the young woman. In other embodiments, a middle layer may include more than one element in one or more pieces.

In this example, the middle layer 12 is approximately the same size and shape as the silhouette 18 on the bottom layer 16. When the middle layer 12 is positioned over the silhouette 18 on the bottom layer 16, the silhouette 18 is not visible.

Other embodiments of the inventions may include a silhouette on the bottom layer that is not completely covered by the middle layer, or may include a silhouette on the bottom layer that is more than completely covered by the middle layer (i.e., the middle layer overlaps the silhouette on the bottom layer).

A user may color and/or decorate the middle layer 12 (in whole or part) prior to positioning the middle layer 12 and/or the remaining layer. Alternatively, a user may elect to color and/or decorate the middle layer 12 when the remaining layer is positioned.

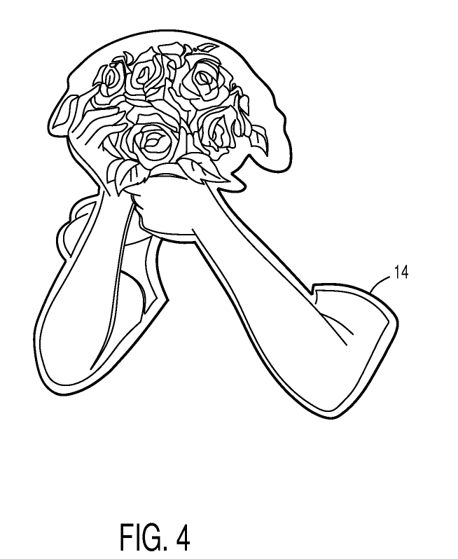

FIG. 4 illustrates the exemplary top layer 14, which, unlike the middle layer 12 includes more than one selected element. Exemplary top layer 14 includes a bouquet and parts of the arms and gown of the young woman shown in the middle layer 12. For ease of reference, all of the element shown in the top layer 14 are referred to as the “bouquet”. The top layer 14 is approximately the same size and shape as the silhouette 20 on the middle layer 12. When the top layer 14 is positioned over the silhouette 20 on the middle layer 12, the silhouette 20 is not visible.

Other embodiments of the inventions may include a silhouette on the middle layer that is not completely covered by the top layer, or may include a silhouette on the middle layer that is more than completely covered by the top layer (i.e., the top layer overlaps the silhouette on the middle layer).

A user may color and/or decorate the top layer 14 (in whole or part) prior to positioning it with respect to the other layers. Alternatively, a user may elect to color and/or decorate the top layer 14 when one or more of the other layers is decorated and/or positioned.

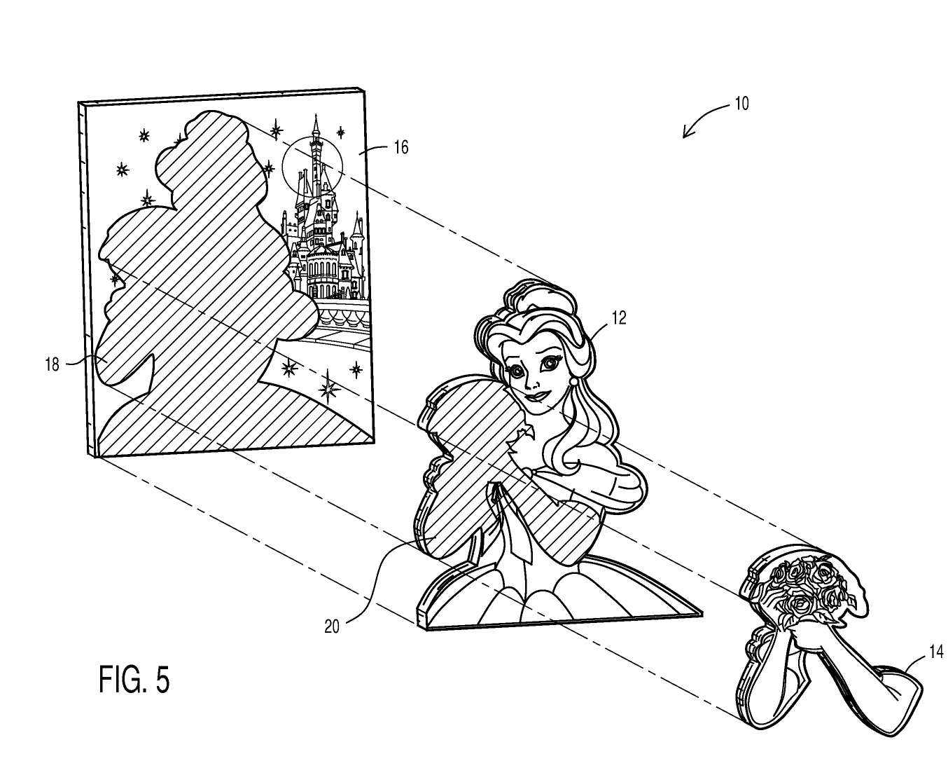

FIG. 5 is an exploded view of the exemplary device 10 and shows how the layers 12, 14, 16 may be positioned or placed with respect to each other. The middle layer including the young woman 12 is positioned over the silhouette 18 on the bottom layer 16. The middle layer 12 may include an adhesive (on the underside of the middle layer 12) or otherwise may be fixed in position to the bottom layer 16. When the middle layer 12 is positioned over the bottom layer 16, the young woman appears to pop-out of the overall drawing. The exemplary middle layer 12 is approximately twice as thick (4 mm) as the bottom layer 16. Thus, the middle layer 12 is approximately 4 mm closer to the viewer than the bottom layer 16. The thickness of the middle layer may vary among embodiments (and/or within a device), and in some cases, a middle layer may be less thick than its respective bottom layer.

The exemplary middle layer 12 includes the line-drawing of the young woman, but does not include the line drawing of the bouquet. Instead of the bouquet, the exemplary middle layer 12 includes a silhouette 20 corresponding generally in size and shape to the exemplary top layer including the bouquet 14. The silhouette 20 is included in the exemplary middle layer 12 where the top layer 14 is to be properly positioned with respect to the overall drawing of the design 10. The alternatives suggested above with respect to the bottom layer 16 (such as possible differences in silhouette size, shape, etc. in other embodiments) are generally applicable to the middle layer 12 as well.

FIG. 5 shows the top layer including the bouquet 14 positioned over the silhouette 20 on the middle layer 12. The top layer 14 may include an adhesive (on the underside of the top layer 14) or may be otherwise fixed in position to the middle layer 12. When the top layer 14 is positioned over the middle layer 12, the bouquet as well as the young woman appear to pop-out of the overall drawing. The exemplary top layer 14 is approximately the same thickness as the middle layer 12, which is twice as thick (4 mm) as the bottom layer 16. Thus, the top layer 12 is approximately 8 mm closer to the viewer than the bottom layer 16. The thickness of the top layer may vary among embodiments, and in some cases, may be less thick than the their respective bottom layers. Moreover, the middle layer and top layer do not have to be the same thickness.

When the layers 12, 14, 16 are properly positioned with respect to each other, the exemplary device 10 may appear as it is shown in FIG. 1.

### ALTERNATIVE EMBODIMENTS

There are many alternative configurations of the design according to the inventions. For example, the base layer of a design may have a drawing on each of its sides. The designs on each side may be the same or different. The selected elements making up the other layers of the design may be used on only one of the sides or on both sides. Different selected elements and/or layers may be used on the respective sides of the base layer.

Another example of an alternative embodiment may include more than the three layers described above. Such an embodiment may have only two layers—a base layer and a top layer, or may have more than 3 layers.

Yet another example of an alternative embodiment may include a single base layer, but may include two or more sets of other layers. Such an embodiment might include a single base layer and three sets of two other layers. This embodiment may include three different blacked-in silhouettes for the respective positioning of the three middle layers of the three sets. Each of the middle layers may include a blacked-in silhouette for positioning of the appropriate top layer. An alternative to this embodiment may include a disparate number of middle layers versus top layers. In the alternative, a base layer may include three different blacked-in silhouettes for the respective positioning of the three middle layers of the three sets. One of more of the three middle layers, however, may include blacked-in silhouettes for positioning of two or more top layers. Other combinations are possible.

### CONCLUSION

The exemplary embodiments of the present inventions were chosen and described above in order to explain the principles of the invention and their practical applications so as to enable others skilled in the art to utilize the inventions including various embodiments and various modifications as are suited to the particular uses contemplated. The examples provided herein are not intended as limitations of the present invention. Other embodiments will suggest themselves to those skilled in the art. Therefore, the scope of the present invention is to be limited only by the claims below.

I claim:

1. An apparatus to give a design a three-dimensional (3-D) characteristic, comprising:
a board having an indicator for positioning a middle piece on the board, and the board including at least a first element of the design;
the middle piece being shaped substantially the same as the indicator and substantially covering the indicator when the middle piece is placed over the indicator on the board,
the middle piece having a positioning aid for placing a top piece on the middle piece, and the middle piece including at least a second element of the design; and
the top piece being shaped substantially the same as the positioning aid and substantially covering the positioning aid when the top piece is placed over the positioning aid on the middle piece, and
the top piece including at least a third element of the design,
whereby positioning the middle piece on the board and placing the top piece on the middle piece gives the design the 3-D characteristic.

2. The apparatus of claim 1, wherein the first, second, and third elements of the design comprise line drawing including at least a space in the line drawing in each of the first, second, and third elements,
whereby decoration may be added to one or more of the spaces.

3. The apparatus of claim 1, wherein the board, the middle piece, and the top piece are each substantially flat; and
wherein the board is thicker than either the middle piece or the top piece.

4. The apparatus of claim 1, wherein the middle piece can be made to adhere to the board; and
wherein the top piece can be made to adhere to the middle piece.

5. The apparatus of claim 1, further comprising a means for supporting the board with the positioned middle and top pieces to display the design with the 3-D characteristic.

6. The apparatus of claim 1, wherein the indicator comprises a first shaded area; and
wherein the positioning aid comprises a second shaded area.

7. The apparatus of claim 1, wherein the board comprises another indicator for use in positioning another middle piece on the board; and
wherein the another middle piece is shaped substantially the same as the another indicator and substantially covers the another indicator when the another middle piece is placed on the another indicator on the board.

8. The apparatus of claim 1, wherein the middle piece comprises another positioning aid for use in placing another top piece on the another middle piece; and
wherein the another top piece is shaped substantially the same as the another positioning aid when the another top piece is placed on the another positioning aid on the middle piece.

9. The apparatus of claim 1, wherein the board is substantially flat and comprises a top and a back, and
wherein the middle piece and the top piece are positioned on top of the board, and
wherein the back of the board comprises a back indicator for positioning a back piece on the back of the board.

10. A device, comprising:
a drawing on top of a base;
a piece positionable on a part of the drawing on the base,
the piece having a top, and the top of the piece including a substantial duplication of the part of the drawing on the base over which the piece is positionable; and
a top piece positionable on a portion of the substantial duplication on the piece,
the top piece having a top area, and the top area of the top piece including a substantial duplicate of the portion of the substantial duplication on the piece over which the top piece is positionable.

11. The device of claim 10, wherein the piece is shaped the same as the part of the drawing on the base over which the piece is positionable.

12. The device of claim 10. wherein the top piece is shaped the same as the portion of the substantial duplication on the piece over which the top piece is positionable.

13. The device of claim 10, further comprising:
another piece positionable on another part of the drawing on the base,
the another piece having a corresponding top, and
the corresponding top of the another piece including a substantial copy of the another part of the drawing on the base over which the another piece is positionable.

14. The device of claim 10, further comprising:
another top piece positionable on another portion of the substantial duplication on the piece, the another top piece having a corresponding top area, and the corresponding top area of the another top piece including a substantial duplicate of the another portion of the substantial duplication on the piece over which the another top piece is positionable.

15. An apparatus for accentuating elements of a design, comprising:
a design having top, middle and bottom elements;
a top part having a top depicting the top element of the design;
a middle part depicting the middle element of the design on top of the middle part, and
the middle part including an area for placement of the top part without covering the middle element of the design; and
a bottom part depicting the bottom element of the design on top of the bottom part, and
the bottom part including a space for placement of the middle part without covering the bottom element of the design,
whereby placing the middle part on the space of the bottom part without covering the bottom element of the design, and placing the top part on area of the middle part without covering the middle element of the design accentuates the middle and top elements of the design.

16. The apparatus of claim 15, wherein the area for placement of the top part comprises a shaded area.

17. The apparatus of claim 15, wherein the space for placement of the middle part comprises a shaded area.

18. A three-dimensional (3-D) puzzle, comprising:
a substantially flat board having a first indicator for positioning a first middle piece on top of the board, and having a second indicator for placing a second middle piece on top of the board;
the first middle piece being shaped substantially the same as the first indicator, and the second middle piece being shaped substantially the same as the second indicator, and
the first middle piece having a first positioning aid for positioning a first top piece on top of the first middle piece, and the second middle piece having a second positioning aid for positioning a second top piece on top of the second middle piece; and
the first top piece being shaped substantially the same as the first positioning aid, and the second top piece being shaped substantially the same as the second positioning aid.

19. The 3-D puzzle of claim 18, wherein the substantially flat board has a back opposite to the top of the board, the back of the board having a back indicator for positioning a back piece on the back of the board.
